(19) United States
(12) Patent Application Publication
(10) Pub. No.: US 2016/0096343 A1
(43) Pub. Date: Apr. 7, 2016

(54) DOUBLE SHEET ALUMINUM PANEL AND METHOD FOR MANUFACTURE THEREOF

(71) Applicant: Alcoa Architectural Products SAS, Merxheim (FR)

(72) Inventors: Laure Quiquerez, Michelbach (FR); Eric Rominger, Niederhergheim (FR)

(21) Appl. No.: 14/873,556

(22) Filed: Oct. 2, 2015

Related U.S. Application Data
(60) Provisional application No. 62/058,735, filed on Oct. 2, 2014.

(51) Int. Cl. B32B 7/12; B32B 15/092; B32B 15/082; B32B 37/06; B32B 7/02; B32B 37/12; B32B 37/10; B32B 15/08; B32B 15/20

(52) U.S. Cl. CPC B32B 7/12; B32B 15/08; B32B 15/092; B32B 15/082; B32B 15/20; B32B 7/02; B32B 37/12; B32B 37/10; B32B 37/06; B32B 2307/54; B32B 2307/544; B32B 2307/546; B32B 2307/3065; B32B 2419/00

(57) ABSTRACT

A double sheet aluminum panel has a first layer of a first aluminum material attached to a second layer of a second aluminum material by an adhesive, such as a thermosetting polymer disposed there between, producing a non-flammable panel. In a method for making the panel, the adhesive is applied to one or both sheets of aluminum, heated, then pressure rolled to distribute the adhesive into a thin film that bonds the two layers of aluminum together. The layers may be of the same or different composition and thickness and may be subjected to anodization and conversion coating.

### CROSS REFERENCE TO RELATED APPLICATIONS

The present application claims the benefit of U.S. Provisional Application No. 62/058,735 entitled, DOUBLE SHEET ALUMINUM PANEL AND METHOD FOR MANUFACTURE THEREOF, filed Oct. 2, 2014, which is incorporated by reference herein in its entirety.

### FIELD

The present invention relates to building materials and architectural products and more particularly, to panels, such as metal panels used for forming exterior and interior surfaces of a building.

### BACKGROUND

Various building materials are known, including aluminum sheet, plate and composite aluminum panels, such as, Reynobond® ACM, PE and FR composite aluminum alloy architectural panels available from Alcoa Architectural Products of Eastman Ga., USA. Due to their mechanical properties, composite panels, such as those using two layers of aluminum alloy sheet on either side of an interior core, have a wide variety of applications, such as in aircraft construction or for use in architecture. In architecture, composite panels (also known as sandwich elements) have many applications, such as for external cladding of buildings, shop awnings, signage and ceilings. In many cases, composite panels exhibit at least three layers, in particular, a core layer and two outer layers attached to either side of the core. Composite panels can exhibit many advantageous features, such as being light in weight, durable and easy to maintain. Notwithstanding, alternative types of architectural panels having different sets of properties remain of interest.

### SUMMARY

The disclosed subject matter relates to a panel having a first layer of a first aluminum material, a second layer of a second aluminum material disposed substantially parallel to the first layer and an adhesive disposed between the first layer and the second layer, attaching the first layer to the second layer.

In one embodiment, the first aluminum material is substantially the same as the second aluminum material.

In another embodiment, the first aluminum material is different from the second aluminum material.

In another embodiment, the first aluminum material has greater reflectivity than the second aluminum material and the second aluminum material has greater mechanical strength than the first aluminum material.

In another embodiment, at least one of the first aluminum material or the second aluminum material is at least one of 3,000 or 5,000 series aluminum alloy.

In another embodiment, both the first and second aluminum materials are a 3,000 or 5,000 series aluminum alloy.

In another embodiment, the first and second layers are of substantially the same thickness.

In another embodiment, the first and second layers are of different thicknesses.

In another embodiment, the thickness of the panel is in the range of 1 mm to 10 mm.

In another embodiment, the first and second layers are of substantially the same thickness and the thickness of the panel is about 3 mm.

In another embodiment, the first and second layers are approximately 1.5 mm in thickness.

In another embodiment, the adhesive is a thermosetting polymer.

In another embodiment, the adhesive is at least one of epoxy, acrylic, phenolic polysulfone or polyimide resin.

In another embodiment, the panel displays a stiffness of about 2.4 lbs/square inch and a yield strength of about 23.3 lbs./inch².

In another embodiment, the panel displays flexural modulus of about 13.7×10⁶ lbs./inch².

In another embodiment, the panel displays a fire performance rating of Class A under ASTM E84.

In another embodiment, a method for making a panel includes the steps of providing a first sheet of a first aluminum material; providing a second sheet of a second aluminum material; applying an adhesive to at least one surface of the first or second sheets; roll bonding the first and second sheets together with the adhesive there between to form a laminate sheet with the first and second sheets attached to each other by the adhesive; and cutting the laminate sheet into panels.

In another embodiment, the adhesive is a thermosetting polymer and further including the step of heating the adhesive to a cure-initiating temperature before roll bonding is performed.

In another embodiment, further including the step of abrading the surface to which the adhesive is applied before the adhesive is applied.

In another embodiment, further including the step of treating the surface to which the adhesive is applied with conversion coating before the adhesive is applied.

In another embodiment, further including the step of painting a surface of at least one of the first and second sheets distal to the adhesive before the adhesive is applied.

In another embodiment, further including the step of anodizing at least the surface to which the adhesive is applied before the adhesive is applied.

In another embodiment, further including the step of pre-stressing the first and second sheets before the step of applying adhesive.

In another embodiment, wherein the pressure applied to the sheets during roll bonding presses the sheets together and squeezes the adhesive between the sheets to form a thin film.

In another embodiment, wherein the adhesive is applied to both sheets before roll bonding.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is a schematic sectional view of a double sheet aluminum panel according to a first embodiment of the present disclosure;

FIG. 2 is a schematic sectional view of a double sheet aluminum panel according to a second embodiment of the present disclosure;

FIG. 3 is a schematic view of an apparatus and method for manufacturing a double sheet aluminum panel in accordance with an embodiment of the present disclosure.

### DETAILED DESCRIPTION OF EXEMPLARY EMBODIMENTS

An aspect of the present disclosure is the recognition that it would be desirable to have a an aluminum containing panel with desirable mechanical properties which also satisfies fire resistance standards promulgated in various jurisdictions for various uses, as described herein. Hospitals, tunnels and stadiums require architectural panels which are incombustible, as measured by various standards prevalent in different jurisdictions. For example, in Europe, this requirement is specified in European-standard EN 13501-1. Depending on properties like fire performance, smoke generation, burning droplets etc., materials are classified in Europe in different categories and given a label designation. A view of the different classes specified by the European standard, in comparison with the national standards in Germany and France, is shown in table 1 below (effective July 2010).

TABLE 1
Overview of European, German, French flammability
classification

| | Europe | Germany | France |
|---|---|---|---|
| Flammability | (EN-13501) | (DIN 4102) | (NE-P92501) |
| Non-flammable | A1 A2-s1 d0 | A1, A2 | M0 |
| Low flammability | A2-s2 d0, B, C | B1 | Ml, M2 |
| Moderate | D, E | B2 | M3 |
| flammability | | | |
| High flammability | F | B3 | M4 |

According to the European standard EN 13501, a material that fulfils the criteria of non-combustible/non-flammable, is classified as A1 or A2-s1 dO (where s=smoke generation, d=burning droplets). With respect to composite panels, the core material is subjected to various tests, such as the measurement of its calorific value, as defined by ISO 1716. For a classification of non-flammable under the European standard, the heat of combustion must not exceed 3.0 MJ/kg. In contrast, the French standard stipulates a heat of combustion no higher than 2.5 MJ/kg in order to obtain a “MO” (non-flammable) classification.

In order to achieve the rigorous requirements of European standard EN 13501, known composite panels utilize metallic or non-metallic strips that are attached to both sides of the core layer, which is made from organic or inorganic non-flammable materials. These core layers of non-flammable materials tend to be heavy and inflexible and are often not capable of absorbing deformations resulting from mechanical stresses due to thermal expansion of the cover layers. Moreover, known composite panels with a thick core layer often require substantial effort to manufacture. An aspect of the present disclosure is to provide a non-flammable/combustible aluminum based panel, which fulfills the European, German and French standards, which is easy to produce, exhibits flexibility and is capable of absorbing deformations resulting from mechanical stresses of the cover layers. Furthermore, the aluminum panel is easy to process and affix to a structure.

The present disclosure discloses a double sheet aluminum panel, having two aluminum layers attached to each other by means of an adhesive layer disposed there between. The first and second layers are attached to each other by means of an adhesive only, rather than having an intermediate core layer. An aspect of the present disclosure is that a double sheet aluminum panel consisting of two aluminum layers attached to each other by means of an adhesive layer as described herein exhibits properties that fulfil the requirements of the A2-s1, dO/A2/MO class materials according to European, German and French fire certifications.

The adhesive layer of the present invention may be an epoxy, acrylic, phenolic, polysulfone or polyimide resin, a thermoplastic or thermosetting polymer. A thermosetting polymer adhesive provides for a strong bond, while maintaining non-flammability of the resultant composite panel.

The double sheet aluminum panel according to the present disclosure exhibits advantages compared with known composite panels. In particular, the double sheet aluminum panel disclosed herein is easy to produce and provides a low-cost option for producing cladding elements. The double sheet aluminum panel of the present disclosure exhibits similar mechanical properties compared to a monolithic panel, but the absence of various materials combined as a core layer, results in the double sheet aluminum panel of the present disclosure being lighter. The lightness of the double sheet aluminum panel of the present disclosure is of particular utility when used for cladding a high-rise building or in other instances of limited access where ease of handling is desirable. The double sheet aluminum panel is also easier to produce than known composite panels. In some instances, it may be cheaper to produce the double sheet aluminum panel of the present disclosure than a monolithic aluminum panel having the same thickness. It should be noted that the double sheet aluminum panel of the present disclosure is fully recyclable and thus environmentally friendly.

According to a further embodiment of the double sheet aluminum panel of present disclosure, the first aluminum material is substantially the same as the second aluminum material. In this regard, it should be noted that the terminology “substantially the same” refers to the fact that any aluminum material produced, whether it is “pure” aluminum or an aluminum alloy, comprises impurities to at least some degree. “Substantially the same,” therefore means that the first and second aluminum materials are produced in the same way so as to exhibit almost identical composition and conformation. Alternatively, the first aluminum material may be different from the second aluminum material. For example, it may be desirable to combine a bright finishing aluminum or aluminum alloy as the first aluminum material, which is attached to the second layer made of a second aluminum material being composed of a high strength aluminum or aluminum alloy. In this way, the present disclosure provides for a bright finish, high strength aluminum or aluminum alloy panel, which is lightweight.

With reference to another aspect of the present disclosure, the first and/or the second layer of the double sheet aluminum panel may have cover layers on their outer surfaces. These cover layers may be paint layers, in order to improve the aesthetic appearance of the panel. The cover layers may be produced from flammable and/or non-flammable material as long as the non-flammability of the aluminum panel is maintained. The cover layers may be applied in any known manner, such as wet paint or strips of painted material applied to the outer surfaces of the first and/or second layer.

The aluminum material of the first and second layers may be any aluminum material, i.e., pure or alloys, known in the state of the art. In one embodiment, the first and/or second layers of the double sheet aluminum panel may be made from an aluminum-magnesium or aluminum-manganese alloy, which are both lighter and less flammable than other aluminum alloys. The first and/or second aluminum material of the first/second layer can be made from a 3,000 or 5,000 series aluminum alloy.

In another embodiment of the present disclosure, the first and second layers of the double sheet aluminum panel are substantially the same thickness. For example, the first and second layers may both be of a thickness between 0.5 mm and 5 mm or between 1 and 3 mm, e.g., 1.25 mm, 1.5 mm or 2 mm. For use on building surfaces, a thickness of the first and second layers may be 1.5 mm, producing a double sheet aluminum panel which is about 3 mm thick. The first and second layers may have different thicknesses for different applications, such that the double sheet aluminum panel has a total thickness in a range of 1 to 10 mm, e.g., 5 mm, 2 mm, 2.5 mm or 3 mm. Consequently, the first and second layers are complementary to each other so as to produce a double sheet aluminum panel which has the preferred thickness between 1.0 mm to 10 mm. In one example of architectural panels, the double sheet aluminum panel may be about 3 mm thick.

The present disclosure also describes a method for manufacturing a double sheet aluminum panel, which, in one embodiment, includes the following steps: (i) providing a sheet/layer of a first aluminum material; (ii) providing a sheet/layer of a second aluminum material; (iii) applying an adhesive to inner surfaces of the first and/or the second layers; (iv) roll bonding the first and second sheets together along their inner surfaces to form a laminate aluminum sheet consisting of two layers of aluminum material attached to each other by means of the adhesive; and (v) cutting the laminate aluminum sheet into double sheet aluminum panels.

With the aforementioned method, the inventive double sheet aluminum panel can be produced easily in a cost-effective manner. Furthermore, due to the roll bonding of the first and second sheets, the aluminum sheets or layers can be bonded together continuously in a composite line. After the roll bonding process, the continuous laminate composite product can be cut into panels of varying sizes in accordance with a customer's needs.

In the embodiment where the adhesive is a thermosetting polymer, it is heated to start curing before roll bonding is performed. The adhesive may be applied to the inner surfaces of the first and/or second layers, and heated and curing started before the first and second layers arrive at the rollers of the roll bonding apparatus. The adhesive may be heated together with the first and second layers up to a temperature of 250° C.

According to another aspect of the present invention, the method may comprise a surface preparation step for smoothing at least the inner surfaces of the first and second layers by means of abrasion before the adhesive is applied. Additionally, the first and second layers may be cleaned, e.g., with a soap or alkaline solution, prior to application of the adhesive. In one embodiment, the aluminum layers may be subjected to an anodizing process, by passing through a series of chemical baths. In a first bath, a chemical degreaser/cleaner cleans the aluminum of all oils, grease, loose oxides, etc. in order to promote the growth of a uniform anodic layer. The next stage may be a rinse stage, which removes any cleaning residue from the first and second layers. Thereafter, the first and second layers could be passed through a second bath with phosphoric acid as an anodizing substance. After anodizing, the aluminum layers are again rinsed to remove anodizing solution. Finally, the first and second layers may be dried before applying the adhesive to the inner surfaces thereof.

In another embodiment, at least the inner surfaces of the first and second layers are treated with a conversion coating before the adhesive is applied. The purpose of the conversion coating is to enhance the corrosion resistance of the final product and to improve the strength of the bond between the two aluminum layers. The solutions applied as conversion coatings can include hexavalent chromium, fluoride ions, tungsten, vanadium or molybdenum. The conversion coating may be applied by spraying the conversion coating solution onto at least the inner surface of the first and second layers, running the first and second layers through a bath of conversion coating solution or applying the conversion coating solution to the aluminum surfaces with one or more rollers. After the conversion coating has been applied to the surfaces of the first and second layers, the substrate generally has to be dried before the adhesive is applied. The adhesive can be applied by techniques such as roll coating, reversal coating, spraying, impregnation coating, folding, etc.

In addition to the aforementioned method steps, the first and/or second layers may be heat treated before roll bonding is performed. Alternatively or additionally, the first and second layers may be pre-stressed, before the adhesive is applied. In particular, the first and second layers may be stressed more than the specific elastic elongation of the aluminum material and less than the specific brake elongation.

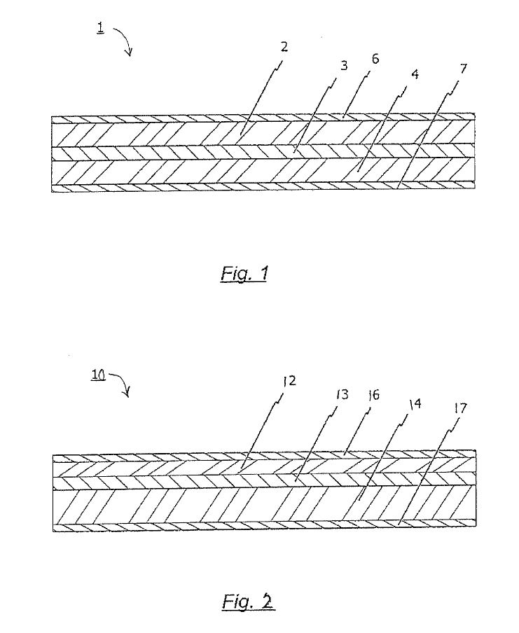

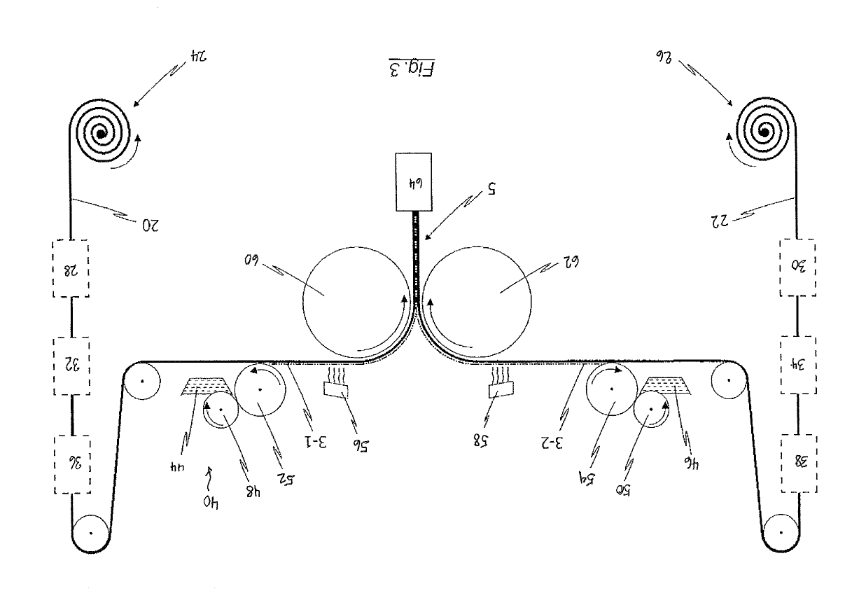

FIGS. 1 and 2 show first and second embodiments of a double sheet aluminum panel 1, 10, respectively, in accordance with the present disclosure. In particular, the double sheet aluminum panels 1, 10 have a first layer 2, 12, respectively, of a first aluminum material attached to a second layer 4, 14, respectively, of a second aluminum material by means an adhesive layer 3, 13, respectively, disposed there between. The adhesive layer 3, 13 may be formed from a thermosetting polymer adhesive, as identified above. In one embodiment, the adhesive layer 3, 13 may be composed of two individual adhesive layers 3-1, 3-2 (FIG. 3) that are merged during roll bonding.

As already mentioned above, the first aluminum material 2, 12 may be substantially the same as the second aluminum material 4, 14, e.g., a 3,000 or 5,000 series aluminum alloy. In FIG. 1, the first and second layers 2, 4 are of substantially the same thickness, e.g., a thickness of 1.5 mm, so as to provide for a double sheet aluminum panel 1 having a thickness of 3 mm. The adhesive layer 3 does not significantly contribute to the thickness of the double sheet aluminum panel 1. The thickness of the adhesive layers 3, 13 depicted in FIGS. 1 and 2 are illustrated schematically and are not necessarily drawn to scale. The roll bonding of the first and second layers 2,4 assures that the they are tightly pressed to together with a very thin coating of adhesive therebetween forming a tight bond. Full curing of the adhesive bonding the layers after roll bonding assures that they are tightly adhered together and a thermosetting adhesive assures that the adhesive will not soften under exposure to solar radiation.

FIG. 2 shows a second embodiment of the double sheet aluminum panel 10, wherein the first and second layers 12, 14 exhibit different thicknesses, i.e., the first layer 12 is thinner than the second layer 14, such that the second layer 4 provides a more significant contribution to the mechanical properties and formability of the double sheet aluminum panel 10 than the first layer 12. FIGS. 1 and 2 additionally illustrate that the first layers 2, 12 and second layers 4, 14 may be covered with outer layers 6, 7 (FIG. 1) and 16, 17 (FIG. 2) which may be decorative/protective layers of paint, printed vinyl, polyester, polyurethane, polyolefin, paper or any combination thereof. In one embodiment, the decorative layers may consist of paint or surface decorative material that simulates wood grain patterns, stone, rock, or other types of surfaces and designs, such as graphics, pictures, etc.

A method and apparatus for manufacturing the double sheet aluminum panel 1, 10 in accordance with the present disclosure is schematically shown in FIG. 3. First and second sheets 20, 22 of first and second aluminum materials are provided. As can be seen from the schematic drawing, these sheets of aluminum material may be provided on coils 24, 26. Alternatively, the aluminum sheets may be provided directly after production thereof, i.e., from a sheet production line/rolling mill.

The first and second aluminum sheets 20, 22 may be pre-treated by optional pre-treating stations 28, 30. As mentioned before, such pre-treatment may include surfacing, roughening, smoothing, cleaning, anodization, heat treatment or pre-stressing of the first and second sheets 20, 22. Afterwards, the outer and/or inner surfaces of the pre-treated sheets 20, 22 may be treated with a conversion coating at conversion coating stations 32, 34. Subsequently, the outer and/or inner surfaces of the treated sheets 20, 22 may be painted at painting stations 36, 38. It should be noted that any/all of the aforementioned stations 28, 30, 32, 34, 36, 38 are optional. The treated aluminum sheets 20, 22 are then passed through adhesive roll coater stations 40, 42 to apply an adhesive layer 3-1, 3-2. At trays 44, 46, an adhesive is gathered by pick-up rolls 48, 50 which transfer the adhesive to applicator rolls 52, 54. The applicator rolls 52, 54 apply the adhesive to the moving sheets 20, 22. In one embodiment, the applicator rolls 52, 54 rotate in opposite directions with their surfaces passing in a direction opposite to the advancing sheets 20, 22, as in the manner of a reverse roll coater. The adhesive may be applied by other methods, such as by spraying but roll application is generally considered to be the best for applying a uniform, thin coating. The adhesive coated sheets 20, 22 are subsequently cured in curing stations 56, 58 to form two individual sheets with a respective adhesive layers 3-1, 3-2, which may be thermoset adhesive layers.

After applying the adhesive to the inner surfaces of the first and second sheets 20, 22, the sheets are subjected to a roll bonding process at pressure rollers 60, 62 to form a roll bonded laminate composite sheet 5. As a last step, the laminate composite sheet 5 may be introduced into a post processing section 64, in which the laminate composite sheet 5 may be cooled, cut and stacked into individual double sheet aluminum panels 1, 10. The method of the present disclosure provides for continuous production of double sheet aluminum panels.

Double sheet aluminum panels 1, 10 disclosed above may be used for an architectural application with a mounting system including anchorages, furring, fasteners, gaskets and sealants, related flashing adapters and masking for a complete installation. In one embodiment, aluminum stiffeners, such as extrusions, may be used on the panels, e.g., on panels of 25 square feet or larger. For example, a stiffener may be utilized for every 25 square feet of panel area.

When used on building exteriors, the double sheet aluminum panels 1 may be designed to withstand the design wind load based upon the local building code, e.g., no less than 20 pounds per square foot (psi) and 30 psf on parapet and corner panels. Wind-load testing may be conducted in accordance with ASTM E330 to obtain the following results: i) Normal to the plane of the wall between supports, deflection of the secured perimeter-framing members shall not exceed L/175 or ¾″, whichever is less; ii) Normal to the plane of the wall, the maximum panel deflection shall not exceed L/60 of the full span; iii) Maximum anchor deflection shall not exceed 1/16″. At 1½ times design pressure, permanent deflections of framing members shall not exceed 1/100 of span length and components shall not experience failure or gross permanent distortion. At connection points of framing members to anchors, permanent set shall not exceed 1/16″.

The double sheet aluminum panels 1, 10 may be used to form a wall meeting the following standards: i) Air Infiltration—When tested in accordance with ASTM E283, air infiltration at 1.57 psf not exceeding 0.06 cubic feet per minute per square foot of wall area; ii) Water Infiltration—Water infiltration is defined as uncontrolled water leakage through the exterior face of the assembly. Systems not using a construction sealant at the panel joints (i.e., Dry Systems) may be designed to drain any water leakage occurring at the joints, with no water infiltration occurring in any system under a differential static pressure of 6.24 psf after 15 minutes of exposure in accordance with ASTM E331. The double sheet panels 1, 10 have been observed to exhibit a fire resistance that passes ASTM E84 Class A and a rainscreen performance for a dry joint, rainscreen system tested as installed in compliance with AAMA 508 and/or AAMA 509.

The aluminum material used for the first layer 2 and the second layer 4 of the double sheet panels 1 may be two tension-leveled 3003-H14 skins having a nominal thickness of 0.063 in (1.51 mm), resulting in a panel 1 thickness of (3 mm)=0.120″ and a weight=1.75 lb/ft2.

The outer layers 6, 7, 16, 17 may be a fluoropolymer coating utilizing 70% PVDF resin, such as are available under the trademark Colorweld® 500, available from Alcoa Architectural Products of Eastman, Ga., U.S.A. that may be factory applied on a continuous-process paint line. The outer layers 6, 7, 16, 17 may include a 0.2 mil (approx.) prime coat and a 0.8 mil (approx.) finish coat containing 70% PVDF resins. (If Colorweld® 500XL is used the layers 6,7, 16, 17 may utilize a 0.2 mil (approx.) barrier prime coat, a 0.80 mil (approx.) color coat, containing 70% PVDF resins and a 0.5 mil (approx.) clear coat containing PVDF resins, resulting in a nominal dry film thickness is 1.50 mils. The gloss preferably meets ASTM D523 standard at 60° in the range of 25 to 30. The outer layers may have a pencil hardness under ASTM D3363 of F-2H or greater, a flexibility T-Bend under ASTM D4145 of 0-2T-Bend, with no pick-off and an adhesion under ASTM D3359 with reverse impact and 1/16″ crosshatch showing no cracking or adhesion loss. A reverse impact under ASTM D2794 1500×metal thickness aluminum preferably shows no cracking or adhesion loss. The double sheet aluminum panel 1, 10 with outer layers 6, 7, 16, 17 may display an acid resistance, showing no effect under ASTM D1308 using 10% muriatic acid for 24 hrs. or 20% sulfuric acid for 18 hrs. An acid rain test under Kesternich SO2, DIN 500180 at 10 cycles min. results in no objectionable color change. An alkali resistance test under ASTM D1308, 10%, 25% NaOH for 1 hr., shows no effect. The double sheet aluminum panel 1, 10 with outer layers 6, 7, 16, 17 may display a salt spray resistance under ASTM B117, 5% salt fog at 95° F., Passing after 4,000 hrs. less than 1/16″ average creep from scribe; up to a few #8 blisters. The sheet 1, 10 displays humidity resistance under ASTM D714 & ASTM D2247 100% relative humidity at 95° F., passing after 4,000 hrs, with #8 blisters. In exterior exposure tests for 10 years at 45° C., South Florida under ASTM D2244 the panel 1, 10 exhibits Max. 5 fade and under ASTM D4214, Max. 8 chalk. The outside layers 2, 4, 12, 14 preferably meet the requirements of AAMA 2605 specifications and have a useful life of more than 20 years of architectural field use.

When a flat double aluminum panel 1, 10 is desired, the panel bow preferably does not exceed 0.8% of panel overall dimension in width or length, and the breaks and curves are preferably sharp and true, with the surfaces free of warps or buckles. The double aluminum panel 1, 10 is preferably visually flat and free of scratches or marks caused during fabrication.

A system utilizing the panels 1, 10 of the present disclosure may be based on a design temperature of 68° F. (20° C.) and assembled such that the panels 1, 10 remain flat regardless of temperature changes and at all times remain air- and watertight. The finish side of the panel 1, 10 may be provided with a removable protective film applied prior to fabrication. The protective film may remain on the panel 1, 10 during fabrication, shipping and erection to protect the surface from damage.

The double aluminum panel 1, 10 of the present disclosure may be used to form architectural systems, such as a: 1) rout-and-return wet system with clips, fasteners, anchors, spacers, trim, flashings, sealant, etc.; 2) rout-and-return dry system with an engineered pressure relief system including extruded perimeter frame; drainage gutter; all extrusions, clips, fasteners, anchors, spacers, trim, flashings, gaskets, sealant, etc.; or 3) rainscreen metal panel system with an engineered pressure relief system including extruded perimeter frame; drainage gutter; all extrusions, clips, fasteners, anchors, spacers, trim, flashings, gaskets, sealant, etc.

In forming architectural systems, extrusions, formed members, sheet and plate shall preferably conform with ASTM B209 and the recommendations of the panel 1, 10 manufacturer. Panel stiffeners, if required, shall be structurally fastened or restrained at the ends and may be secured to the rear face of the panel 1, 10 with silicone of sufficient size and strength to maintain panel flatness. Stiffener material and/or finish should be compatible with the silicone. Flashing materials may be made from 0.040″ or greater thickness aluminum sheet to match the adjacent curtain wall/panel system where exposed. A lap strap under the flashing at abutted conditions and seal lapped surfaces with a full bead of non-hardening sealant may be used as well as concealed/non-corrosive fasteners. A weather barrier may also be used to prevent water penetration, water vapor transmission, and air penetration.

The double aluminum panels 1,10 are preferably erected plumb and level to a support structure with an attachment system that allows for free vertical and horizontal thermal movement due to expansion and contraction for a material temperature range of −40° F. (−29° C.) to +180° F. (+82° C.). Buckling of panels, opening of joints, undue stress on fasteners, failure of sealants or any other detrimental effects due to thermal movement are to be avoided. Fabrication, assembly and erection procedure shall account for the ambient temperature at the time of the respective operation. Assembly should provide for the separation of dissimilar metals through the use of appropriate gaskets and fasteners to minimize corrosive or electrolytic action between metals.

The double sheet aluminum panels 1, 10 of the present disclosure may be pre-painted and used for forming building facades. The panels 1, 10 are flat, dent resistant, durable and meet the same flatness tolerances that are prevalent in traditional aluminum composite materials, e.g., (ACM) for the same size sheets, and carry the same finish warranties, but they are much stiffer than traditional ACM materials in the same thickness, and are capable of being fabricated with the same methods used in plate-aluminum fabrication. The panels 1, 10 combine beneficial attributes of ACM with the benefits of plate material to provide a unique product that can be installed in rout-and return ACM systems or sheet metal attachment systems.

Double sheet aluminum panel 1, 10 may be cut to length at the manufacturing facility and packed on cushioned wooden skids enclosed with a combination of foam and cardboard, banded in both directions in order to minimize movement during shipment. In one embodiment, the panels 1, 10 weigh 1.78 lb/ft2 and are composed of two 1.5 mm (0.063 in) sheets bonded together as described above. In one embodiment, the manufacturing tolerances of the double sheet aluminum panel 1, 10 exhibit a panel width tolerance of +0.062″ (+1.58 mm) to −0.032″ (−0.81 mm), an alignment between the first layer 2, 12 and the second layer 4, 14 within a tolerance of less than or equal to 0.062″ (1.58 mm), a visually flat degree of flatness and a squareness typified by a difference between the diagonals of less than or equal to 0.125″ (3.18 mm).

Double sheet aluminum panel 1, 10 will expand and contract with the same expansion coefficient as solid aluminum; therefore, ambient temperature and the operating temperature range of the installed panels should be considered during fabrication. The usable temperature range for double sheet aluminum panel 1 is −40 to 180° F.

### Cutting and Forming

Double sheet aluminum panel 1, 10 can be machined and formed according to the same methods used for forming Reynobond® PE and FR core composite panels, available from Alcoa Architectural Products of Eastman, Ga., USA. Sawing and routing can be performed with ordinary commercial metal and woodworking equipment. Cutting sheets can be performed with either a circular saw or a milling bit. The panels 1, 10 can be cut with a metal-cutting circular saw used to cut aluminum sheets. In order to maintain a long tool life, only one double sheet aluminum panel 1, 10 sheet should be sawed during a cycle of the saw blade. Line cuts may be made with an 8″ diameter, 80 tooth, carbide-tipped combination rip and crosscut blade. When performing a cut with a circular saw, the panels should be placed on their back side with the protective film facing opposite the frame of the saw.

Automated vertical and horizontal panel saws are available through equipment manufacturers and distributors that allow multiple vertical and horizontal routs and cuts to be made on one sheet at a time. Double sheet aluminum panels 1, 10 are usually mounted vertically in the fixture, and the cutting operation performed in this manner requires less shop floor area than if the panels are placed flat on a table. Panel saws can streamline the fabrication process. Grooved cuts can be performed on the double sheet aluminum panel 1, e.g., using a 110° tungsten-carbide bit with a 1/16″ wide flat-nose traveling at a feed rate less-than or equal-to 3 feet per-minute and spinning at 24,000 rpm's. This method gives good results for cutting a 90° fold, which can be used for a return leg. The plunge depth of the bit should leave no less than 0.7 mm or 0.032 inches of metal remaining in the groove. Return legs should be turned using a U-shaped jig with a manual lever, and should not be bent more than one times. If the return leg is longer than four feet, multiple jigs should be used at the same time to perform the bend in one motion. In order to ensure full bending, it is recommended to bend the leg at least 10° past the intended angle and to allow it to relax back to the desired angle. Recommended bit angles for v-groove cutting are between 90° to 135°, but the bit should always have at least a 1/16″ wide flat-nose.

Double sheet aluminum panel 1, 10 can be folded like aluminum plate with a metal folding machine. When performing folds, tooling should allow for a 2-T bend to avoid crazing the finish or cracking paint on the surface of the panel 1, 10. Folds can be made up to a 90° angle. Corners may be mitered with a 90° sharp-nose grooving bit when folding return legs together. Double sheet aluminum panels 1, 10 can be radiused to curved configurations for column covers, architectural bullnoses, radius-building corners and other applications requiring radius forming. This process can be accomplished with a “pyramid” rolling machine, which consists of three or four motor-driven adjustable rollers. The multiple layers of the double sheet aluminum panel 1, 10 causes a spring-back effect that is more pronounced than with aluminum sheet. In 3-roll formers, the leading and exiting edge of the panel will be flat. To compensate for this, 3-5″ of extra length may be used. In one embodiment, a minimum radius for the panels is 6″ and this may require multiple passes through the rollers.

### Attachment and Assembly

Double sheet aluminum panels 1, 10 can be easily installed for both exterior and interior applications. Wet-seal and rainscreen systems are options. A rout-and-return installation is accomplished with a continuous V-shaped routed groove made around the entire panel perimeter at a constant distance, e.g., of 1″ (25 mm) from the panel edge. A minimum thickness of, e.g., 0.032″ (0.81 mm) of face material must remain after routing. The corners are removed and the edges are folded to create a 1″ (25 mm)-deep “pan” or cassette. The corners may be reinforced with riveted aluminum angles to stiffen the panel unit.

Rivets may be used for fastening the panels 1 to aluminum angles that are then used to secure the panel 1, 10 to a structural member. Rivets are preferably placed at a distance of at least 10 mm from the edge of the sheet. This value may change according to the loading requirements of the panel 1, 10 and varies with the thickness of the material to be joined to the panels. When used outdoors, a running clearance of 2 mm between the minimum diameter and the diameter of the rivet hole of the double sheet aluminum panel 1, 10 panel to reflect the linear expansion coefficient of 1.136−10-3 in/in/° F. (0.0236 mm/m/° C.) may be used.

Attachment using countersunk screws with bolts is a secondary method of attachment, but this method does not accommodate for expansion or contraction at fastening points. Washers may be used to distribute the clamping loads exerted by threaded fasteners. Assembly without a washer could cause creep and significantly reduce the clips' performance.

Double sheet aluminum panels 1, 10 can be welded using techniques similar to those used for welding aluminum plate. Welding can be useful for stud welding projection studs to the back of panels, but is not recommended for closing corners. When performing a stud weld, any finish is ground off the back side of the panel 1, exposing bare aluminum. Once the finish is removed, a 5000 series aluminum stud can be arc welded to the surface. Welding temperatures and parameters should follow the stud weld manufacturer's guidelines, but should not produce enough heat on the opposite surface to damage the front finish. Only aluminum studs should be used for this process.

It is possible to install panels into specially designed extrusions which pinch the panel into a specially designed channel. Depending on the shape of the profile, it may be possible, before assembly, to tighten the flanges of the profile to improve the strength of the mounting system. For mounting outdoors or for large panels, additional fastening rivets hidden under the extrusion may provide extra support.

### Panel Reinforcement

Double sheet aluminum panels 1, 10 can be strengthened in various ways to resist wind and reduce deflection. For example, stiffeners in the form of 1″ to 1.5″ aluminum extrusions may be used, the size depending on the magnitude of support required. These extrusions are bonded to unexposed backside of the panel at regular intervals, e.g., by adhesive or silicone seal, and act as supporting beams. Wind or pressure differential force on the panel 1, 10 is transferred to the stiffeners, which transfer the force outwardly to the edge of the panel. Stiffeners are most effective if they are attached across the shortest panel dimension. Fasteners used to attach the panel 1, 10 to the structural supports should be placed as close to the stiffener end location as possible, so that the loads can be transferred from the stiffener to the support in the most direct manner. Stiffener spacing depends on variables, such as the strength of the stiffeners, their spacing, the wind force, the maximum deflection, the strength of the attachments and the spacing of the supports. Since the maximum deflection of the panel 1, 10 is located at its geometric center, it is necessary to place a stiffener in the middle of the panel, and then position the other stiffeners at regular intervals. Double sheet aluminum panels 1, 10 may be seamlessly matched to known structural panels, such as Reynobond® PE, ASM and FR aluminum panels and Reynolux® panels.

In one example, double sheet aluminum panels 1 have two coil coated 1.5 mm ( 1/16″) aluminum sheets bonded together by adhesive, yielding a total panel thickness of about 3 mm (⅛″) exhibits the following properties.

U.S. and Metric Equivalent

| Property | Units | Double sheet aluminum |
|---|---|---|
| Thickness | in | 0.120 |
| | mm | 3.0 |
| Weight | lb/ft² | 1.77 |
| | kg/m² | 8.64 |
| Min. Bond Strength | in-lb/in | 25 |
| ASTM D1876 | Nm/m | 103 |
| Allowable Bending Stress | lb/in² | 11,500 |
| | MPa | 79.3 |
| Coeff. of Expansion | in/in/° F. | 0.131 × 10⁻⁵ |
| ASTM E228 | mm/mm/° C. | 2.36 × 10⁻⁵ |
| Stiffness (EI) | lb-in²/in | 2,400 |
| ASTM D393 | MPa-cm⁴/m | 2.7 × 10⁴ |
| Moment of Inertia | in⁴/in | 2.37 × 10⁴ |
| | cm⁴/m | 0.39 |
| Yield Strength | lb/in² | 23.3 |
| ASTM E8 | MPa | 160 |
| Elastic Modulus | lb/in² | 9.7 × 106 |
| ASTM E8 | GPa | 66.9 |
| Flexural Modulus | lb/in² | 13.7 × 10⁶ |
| ASTM C393 | MPa | 9.4 × 10⁴ |

It will be understood that the embodiments described herein are merely exemplary and that a person skilled in the art may make many variations and modifications without departing from the spirit and scope of the claimed subject matter. For example, while two layers of aluminum alloy bonded by a single adhesive layer are described herein, more layers bonded with intermediate adhesive may be employed. All such variations and modifications are intended to be included within the scope of the disclosure.

I/we claim:

1. A panel, comprising a first layer of a first aluminum material, a second layer of a second aluminum material disposed substantially parallel to the first layer, an adhesive disposed between the first layer and the second layer, attaching the first layer to the second layer.

2. The panel of claim 1, wherein the first aluminum material is substantially the same as the second aluminum material.

3. The panel of claim 1, wherein the first aluminum material is different from the second aluminum material.

4. The panel of claim 3, wherein the first aluminum material has greater reflectivity than the second aluminum material and the second aluminum material has greater mechanical strength than the first aluminum material.

5. The panel of claim 1, wherein at least one of the first aluminum material or the second aluminum material is at least one of 3,000 or 5,000 series aluminum alloy.

6. The panel of claim 5, wherein both the first and second aluminum materials are a 3,000 or 5,000 series aluminum alloy.

7. The panel of claim 1, wherein the first and second layers are of substantially the same thickness.

8. The panel of claim 1, wherein the first and second layers are of different thicknesses.

9. The panel of claim 1, wherein the thickness of the panel is in the range of 1 mm to 10 mm.

10. The panel of claim 9, wherein the first and second layers are of substantially the same thickness and the thickness of the panel is about 3 mm.

11. The panel of claim 10, wherein the first and second layers are approximately 1.5 mm in thickness.

12. The panel of claim 1, wherein the adhesive is a thermosetting polymer.

13. The panel of claim 1, wherein the adhesive is at least one of epoxy, acrylic, phenolic polysulfone or polyimide resin.

14. The panel of claim 10, wherein the panel displays a stiffness of about 2.4 lbs/square inch and a yield strength of about 23.3 lbs./inch².

15. The panel of claim 14, wherein the panel displays flexural modulus of about 13.7×10⁶ lbs./inch².

16. The panel of claim 10, wherein the panel displays a fire performance rating of Class A under ASTM E84.

17. A method for making a panel, comprising the steps:
(A) providing a first sheet of a first aluminum material;
(B) providing a second sheet of a second aluminum material;
(C) applying an adhesive to at least one surface of the first or second sheets;
(D) roll bonding the first and second sheets together with the adhesive there between to form a laminate sheet with the first and second sheets attached to each other by the adhesive;
(E) cutting the laminate sheet into panels.

18. The method according to claim 17, wherein the adhesive is a thermosetting polymer and further comprising the step of heating the adhesive to a cure-initiating temperature before roll bonding is performed.

19. The method according to claim 17, further comprising the step of abrading the surface to which the adhesive is applied before the adhesive is applied.

20. The method according to claim 17, further comprising the step of treating the surface to which the adhesive is applied with conversion coating before the adhesive is applied.

21. The method according to claim 17, further comprising the step of painting a surface of at least one of the first and second sheets distal to the adhesive before the adhesive is applied.

22. The method according to claim 17, further comprising the step of anodizing at least the surface to which the adhesive is applied before the adhesive is applied.

23. The method of claim 17, further comprising the step of pre-stressing the first and second sheets before the step of applying adhesive.

24. The method of claim 17, wherein the pressure applied to the sheets during roll bonding presses the sheets together and squeezes the adhesive between the sheets to form a thin film.

25. The method of claim 24, wherein the adhesive is applied to both sheets before roll bonding.
